(19) United States
(12) Patent Application Publication
(10) Pub. No.: US 2026/0361152 A1
(43) Pub. Date: Nov. 12, 2026

(54) Stator for a radial flux double-rotor machine, method for producing a stator for a radial flux double-rotor machine and a radial flux double-rotor machine

(71) Applicant: DeepDrive GmbH, Garching bei München (DE)

(72) Inventors: Dean PETROVSKI, München (DE); Stefan ENDER, Bergheim (DE)

(21) Appl. No.: 19/151,193

(22) PCT Filed: Jan. 19, 2024
(86) PCT No.: PCT/EP2024/051244

§ 371 Date: Jul. 25, 2025

(30) Foreign Application Priority Data
Jan. 27, 2023 (DE) 10 2023 101 990.2

(51) Int. Cl. H02K 1/16; H02K 3/28; H02K 15/026; H02K 15/0643; H02K 15/33; H02K 16/04

(52) U.S. Cl. CPC H02K 1/16; H02K 3/28; H02K 15/026; H02K 15/0643; H02K 15/33; H02K 16/04

(57) ABSTRACT

The present invention relates to a stator for a radial flux double-rotor machine with a stator core, a winding disposed in the stator core, which winding is configured to be self-supporting for torque support of the stator, wherein the winding is formed from interconnected conductor rods and has a radially inner layer of helically arranged conductor rods and a radially outer layer of oppositely helically arranged conductor rods, wherein the conductor rods are each configured to be bent at a first conductor rod end and non-bent at a second conductor rod end, wherein the first conductor rod ends of the conductor rods of the radially outer layer are arranged in such a manner that the bending is oriented radially inwards in each case, and the first conductor rod ends of the conductor rods of the radially inner layer are arranged in such a manner that the bending is oriented radially outwards in each case.

### CROSS-REFERENCE TO RELATED APPLICATION

This application is a Section 371 National Stage Application of International Application No. PCT/EP2024/051244, filed on Jan. 19, 2024, entitled “STATOR FOR A RADIAL-FLOW DOUBLE ROTOR MACHINE, METHOD FOR PRODUCING A STATOR FOR A RADIAL-FLOW DOUBLE ROTOR MACHINE, AND RADIAL-FLOW DOUBLE ROTOR MACHINE”, and published as WO 2024/156605 A1, published Aug. 2, 2024, not in English, which claims priority to German Patent Application No. 102023101990.2 filed on Jan. 27, 2023, the contents of which are incorporated herein by reference in their entireties.

### FIELD OF INVENTION

The present invention relates to a stator for a radial flux double-rotor machine, in particular for a wheel hub motor, a method for producing a stator for a radial flux double-rotor machine and a corresponding radial flux double-rotor machine, in particular for a wheel hub drive.

### TECHNICAL BACKGROUND

Electric machines comprising a stator and two rotationally fixed rotors, so-called double-rotor machines (also referred to as multi-rotor, dual-rotor, etc.) can increase both the torque density as well as the efficiency of electric drives when compared to conventional electric machines comprising solely one rotor. This is due to the fact that, in particular in the so-called “yokeless” design, no magnetic return circuit is required in the stator, and as a result the hysteresis losses can be significantly reduced. In addition, with two rotors there is generally more space available for the field-exciting magnets (in permanent magnet synchronous machines, PSM) or the conductor material (in induction machines, IM or electrically excited synchronous machines, ESM). According to the orientation of the magnetic field lines in the air gap, such machines can be divided into two groups, axial flux carrying (field lines parallel to the axis of rotation, so-called axial flux machines) on the one hand and radial flux carrying (field lines in radial direction in the air gap, so-called radial flux machines) on the other.

Axial flux double rotor machines are described, for example, in DE 10 2015 226 105 A1 and DE 10 2013 206 593 A1. They are characterized by a high torque and power density, however they are costly to manufacture since very complex geometries have to be punched or produced by powder metallurgy in the stator core. Until now, such machines have therefore not made the leap into large-scale production and are only used in niche areas with high power density requirements, such as racing and aviation. Moreover, the mechanical mounting concepts for the stator winding allow solely the use of single-tooth windings with corresponding disadvantages in terms of noise excitation.

In contrast, in the case of radial flux double-rotor machines, there can be used manufacturing methods which, in principle, are established for the winding and laminated core and are suitable for large-scale production. However, in this case there exists a major and largely unsolved technical challenge in supporting the torque generated in the stator core. Due to the internal and external rotating parts, the stator laminated core cannot be mounted in a fixed housing (e.g. pressed-in, screwed or adhered) as is usually the case. The torque is therefore directed to the axial ends of the stator laminated core or stator winding and supported there. Various approaches are proposed in the prior art, all of which, however, are connected with significant disadvantages in terms of function and/or cost.

EP 1 879 283 B1 describes a possibility of designing the stator winding as a so-called yoke winding. In this case, the ring-shaped stator laminated core has grooves on the inner and outer diameters, between which there is a magnetic return (also known as a stator yoke) that is effective in the tangential direction. Here, the forward and return conductors of each winding strand are guided in grooves lying radially above each other and wound around the yoke. The stator yoke is axially accessible between the winding strands and can, for example, be fixed to the housing by axial screw connections (e.g. described in JP 2018 082 600).

The axial compression of the screws ensures both torsional rigidity of the laminated core and torque support at the axial end. The north pole and south pole of the rotor field are positioned opposite each other. The disadvantage of this concept is that the magnetic flux must be guided completely via the return yoke located between the stator grooves. On the one hand, this leads to an increased weight of the stator laminated core and significantly increases iron losses. The magnetic field lines of both rotor fluxes close via the magnetic return flux in the stator core and cause iron losses there. In addition, all individual coils of the yoke winding must be interconnected in parallel or in series in the area of the winding head, which in turn leads to an installation space conflict with the torque support. However, the winding wound around the yoke allows direct mechanical contact with the laminated stator core.

A significant reduction in weight and losses can be achieved if the magnetization directions of the magnets lying radially one above the other point in the same direction and the current flow directions of the conductors lying one above the other in the grooves are identical. In this case, the magnetic return circuit in the stator can be omitted, resulting in a so-called “yokeless” double rotor machine with distributed winding. The magnetic field lines close over the rotor. A magnetic return circuit in the stator is not required, resulting in very low weight and iron losses in such machines. However, the distributed winding does not allow direct mechanical contact with the laminated stator core for torque support. For example, WO 2004/004098 A1 describes a yokeless design with distributed winding.

Even with a so-called “yokeless” design, it can still make sense to use a thin yoke for the mechanical connection of the stator teeth, but this is not necessary for electromagnetic purposes. The term “yokeless” therefore refers to electromagnetic flux conduction in which there is no flux in the tangential direction in the stator. However, the winding cannot be designed as a yoke winding, as the forward and return conductors of the winding strands are distributed radially around the circumference and thus form a distributed winding. This results in winding heads with distributed windings that make it difficult to access the laminated core in the axial direction. The purely radial flux routing also prohibits the use of axial, metallic screw connections, as these form conductor loops with a lot of interlinked flux and high additional current heat losses.

For axial support, various auxiliary constructions for torque support are proposed in the prior art, for example described in DE 10 2010 055 030 A1 or U.S. Pat. No. 7,557,486 B2. The problem here is that electrically and/or magnetically conductive metals are not allowed to protrude into the flux-carrying area, or only to a very limited extent, which severely restricts the choice of material and geometric design. In contrast, plastic components, adhesives and/or potting materials can also be used in the flow-carrying area.

However, it is very difficult to achieve the high requirements in terms of temperature stability and mechanical strength with such materials.

### SUMMARY OF THE INVENTION

In view of the above background, it is one of the ideas of the present invention to provide an improved stator for a radial flux double-rotor machine, an improved method for producing a stator for a radial flux double-rotor machine and an improved radial flux double-rotor machine.

Accordingly, the present invention provides
a stator for a radial: flux double-rotor machine, in particular for a wheel hub motor, comprising: a stator core, a winding disposed in the stator core, which winding is configured to be self-supporting for torque support of the stator, wherein the winding protrudes beyond the stator core at at least one axial end; a support device arranged axially offset with respect to the stator core, which is configured for form-fitting engagement with the winding at the at least one axial end for torque support; wherein the winding is formed from interconnected conductor rods and has a radially inner layer of helically arranged conductor rods and a radially outer layer of oppositely helically arranged conductor rods, wherein the conductor rods are each configured to be bent at a first conductor rod end and non-bent at a second conductor rod end, wherein the first conductor rod ends of the conductor rods of the radially outer layer are arranged in such a manner that the bending is oriented radially inwards in each case, and the first conductor rod ends of the conductor rods of the radially inner layer are arranged in such a manner that the bending is oriented radially outwards in each case.
a method for producing a stator for a radial flux double-rotor machine, in particular a stator according to the invention, comprising the steps of: providing a stator core having radially outer stator grooves each describing a helical line and radially inner stator grooves each describing a helical line with the opposite turning direction; providing individual conductor rods which are configured to be bent at a first conductor rod end and which are configured to be non-bent at a second conductor rod end; introducing the individual conductor rods at a first axial end of the stator core into the radially outer stator grooves in such a manner that at the first axial end the bending of the first conductor rod ends of the conductor rods of the radially outer layer is oriented radially inwards; introducing the individual conductor rods at a second axial end of the stator core into the radially inner stator grooves in such a manner that at the second axial end the bending of the first conductor rod ends of the conductor rods of the radially inner layer is oriented radially outwards; and joining the conductor rods introduced into the inner and outer stator grooves at the conductor rod ends in order to form conductor loops, wherein at the first axial end of the stator core the first conductor rod ends of the conductor rods of the radially outer layer are each joined to the second conductor rod ends of the conductor rods of the radially inner layer and at the second axial end of the stator core the first conductor rod ends of the conductor rods of the radially inner layer are each joined to the second conductor rod ends of the conductor rods of the radially outer layer.
a radial flux double-rotor machine, in particular for a wheel hub drive, comprising: a stator according to the invention or produced by a method according to the invention; a first rotor arranged radially inside the stator core of the stator; and a second rotor arranged radially outside the stator core of the stator.

One recognition on which the present invention is based is that the joining of straight conductor rods can be greatly facilitated by reshaping the conductor rod ends.

An idea of the present invention is to use bent conductor rods in order to facilitate joining. The bent conductor rods can thus be joined in the assembled state of the winding without reshaping and with little effort. In particular, in this manner it is advantageously avoided that the conductor rods are first formed in the assembled state, which would be mechanically highly stressful. Using the bent conductor rod ends there can be provided a self-supporting winding in a very simple and particularly economical way.

As a self-supporting design of the winding there is to be understood that there exists sufficient rigidity and strength of the winding against torsion around the machine axis to support the drive torque. In particular, the self-supporting winding is embedded in a soft magnetic stator core for magnetic flux guidance. This has the particular advantage that the stator core itself does not require any inherent torsional rigidity with respect to the machine axis and no other auxiliary construction is required to fix the stator core. The torque is instead supported, in particular completely, via the winding.

Thus, there is achieved a hitherto unknown or in the field of radial flux double-rotor machines not technically implementable functional integration, in that the winding is additionally provided with a load-bearing function to support the torque and mechanically at one axial end there is achieved a fixation of the winding outside the stator core. For the production of such a winding there is proposed an integral production of the winding in the existing stator core. For this purpose, the individual rods of the winding are inserted through the radially inner and radially outer stator grooves in the axial direction following the helical line of the stator grooves and connected at the conductor ends. For example, in this respect, there is provided a material-locking connection by welding or soldering. Therefore, the winding is connected to the stator core in a form-fitting manner.

The bending of the conductor rods at one conductor rod end according to the invention avoids in particular a mechanical deformation of originally straight conductor rod ends radially inwards or radially outwards after mounting a winding within a stator. Rather, the bending is already provided before assembly and can be understood as a spatial projection, offset and/or bend, in particular an angular bend, of the respective otherwise straight conductor rod end. In this manner, in order to form the winding, a radial distance between the radially inner layer of helically arranged conductor rods and the radially outer layer of oppositely helically arranged conductor rods of the winding is spatially bridged by the bending of the respective first conductor rod ends.

The opposite radial orientation of the bending of the conductor rod ends of the respective radial layers is therefore decisive for avoiding subsequent mechanical deformation of the conductor rods. Accordingly, the stator is very easy to manufacture, which advantageously avoids the need for additional process steps. Furthermore, no additional parts, components and/or connections are required to bridge the radial distance between the radially inner layer and the radially outer layer. This therefore also leads to a reduction in the total number of parts of the stator and also reduces the complexity of the assembly.

According to one embodiment, the bending of the respective first conductor rod ends of the conductor rods of the radially outer layer and radially inner layer can also have an additional circumferential component, in particular a twist or torsion of the conductor rod or the conductor rod end. Consequently, the bending of the respective first conductor rod ends of the conductor rods of the radially outer layer and radially inner layer can be configured as a radial and circumferential spatial bridging, in particular in order to achieve an overlap of the conductor rods extending helically in opposite directions and forming a loop. Such an overlap can then be joined directly in a simple manner, for example welded, in particular by laser beam welding, or soldered.

The selected pitch angle (also setting angle) of the stator grooves or the helical lines described therewith ensures that, by connecting the conductor rods introduced, conductor loops are formed. The angle of the conductor loops in the machine, which is swept in relation to the center axis, encloses one magnetic pole of each rotor. In this manner, despite the functional integration, a very simple production of the stator is possible, which requires very few components and comparatively simple conventional connection technology and therefore also very few production steps.

The stator configured in this manner can now be completed with various inner and outer rotors known to the skilled person to form an electrical machine according to the invention. These include, for example, permanent magnet-excited rotors with surface magnets and/or buried magnets, short-circuit rotors or electrically excited rotors Hybrid variants with different rotor variants in the inner and outer rotor can also be provided. A particularly advantageous embodiment results if the rotors are configured from soft magnetic solid material and with surface-mounted permanent magnets. The low upper field spectrum of the winding variants described here and the distance of the solid material from the air gap ensured by the magnets prevent the occurrence of unacceptably high losses due to eddy currents in the rotors.

In this embodiment, comparatively high efficiencies can be advantageously achieved and the rotors can still be manufactured very cost-effectively.

The support device is firmly connected to the base as the stationary part of the electric machine by a suitable method. One possible embodiment provides recesses, for example through-holes, for non-positive fastening means such as screws. Alternatively, or additionally, however, form-fitting connection means and/or a material-locking connection would of course also be conceivable.

According to the invention, the winding is formed from interconnected conductor rods, in particular in the form of rods. In particular, the conductor rod ends can be connected by a material bond, for example by welding or soldering. However, other connection techniques are also conceivable. For example, two conductor rods are connected at the conductor rod ends and all the conductor rods together form a rod structure. The rod structure formed with the conductor rods is advantageously torsionally rigid and designed for torque transmission around the central axis of the stator. Furthermore, the conductor rod ends are designed with a sufficient thickness for power transmission. In the case of a wheel hub motor, for example, the thickness of the conductor rods can be in the range of several millimeters. In particular, the rods may have a square profile with edge lengths of several millimeters.

According to the invention, the winding has a radially inner layer of helically arranged conductor rods and a radially outer layer of oppositely helically arranged conductor rods. In this manner, the winding forms a rod structure which has a high torsional stiffness. The conductor rods of the inner layer and the conductor rods of the outer layer each describe a helical line whose winding directions or pitches are opposite to each other. An angle of the helical line between the start and end of a conductor rod that is swept in relation to the center axis of the stator is formed in particular in such a way that a conductor loop is formed for each pole of the rotors in a radial flux double-rotor machine. The swept angle to be provided can therefore be calculated from the quotient of a whole revolution (2π or 360°) and twice the number of pole pairs.

In particular, the present invention is particularly advantageously applicable to a wheel hub motor, for example for a motor vehicle. Due to the functional integration, the design according to the invention allows the mass of a radial flux double-rotor machine to be reduced and the torque density to be increased, which means a reduction in unsprung masses, particularly in the case of wheel hub motors. Furthermore, according to the invention, a comparatively short axial length can be realized with a comparatively high diameter, which is particularly advantageous inside the wheel in terms of torque support and installation space.

On the other hand, very high torques are also possible according to the invention despite the extremely compact design, which are in particular high enough to drive a vehicle wheel directly without a gearbox. In this manner, transmission losses are avoided in a particularly advantageous way, further weight is saved and particularly high efficiency advantages can be achieved.

Furthermore, this high torque, which is possible in sizes within the dimensions of conventional vehicle rims and is already well into the four-digit range, in particular greater than 5000 Nm, and thus already reaches the adhesion limit of conventional road tires, even allows a rear axle wheel brake to be replaced by the wheel hub motor. Special synergies are thus possible when using the wheel hub motor.

According to one aspect, there is thus further disclosed a vehicle axle, in particular for a motor vehicle, having a radial flux double-rotor machine according to the invention, which is coupled to a drive wheel without gearing.

Disclosed further according to one aspect is a motor vehicle comprising such a vehicle axle.

Advantageous embodiments and further configurations result from the dependent claims as well as from the description with reference to the figures of the drawing.

According to one embodiment, the first conductor rod ends of the conductor rods of the radially outer layer are each joined to the second conductor rod ends of the conductor rods of the radially inner layer to form conductor loops. Furthermore, the first conductor rod ends of the conductor rods of the radially inner layer are each joined to the second conductor rod ends of the conductor rods of the radially outer layer. In this manner, the conductor rods of the radially inner layer and the conductor rods of the radially outer layer are guided towards each other to form the self-supporting winding in order to join them. Furthermore, the joining at the conductor rod ends of the respective conductor rods advantageously provides a mechanically stable winding with improved stress and force distribution.

According to one embodiment, the conductor rods of the radially outer layer are received in outer stator grooves and arranged with the first conductor rod end at a first axial end of the stator core, and the conductor rods of the radially inner layer are received in inner stator grooves and arranged with the first conductor rod end at a second axial end of the stator core. Furthermore, in order to form conductor loops, the first conductor rod ends of the conductor rods of the radially outer layer are joined to the second conductor rod ends of the conductor rods of the radially inner layer at the first axial end in each case, and the first conductor rod ends of the conductor rods of the radially inner layer are joined to the second conductor rod ends of the conductor rods of the radially outer layer at the second axial end in each case. In this manner, the conductor rods of the radially inner layer and radially outer layer of the winding are embedded, in particular fully embedded, in the respective inner and outer stator grooves. Furthermore, a stator with a high power density and a small structural size is thus provided.

According to one embodiment, the first conductor rod ends are joined to the second conductor rod ends at the overlap abutment, in particular by laser beam welding. The overlap abutment can be formed as an overlap of the respective surfaces of the first conductor rod ends and second conductor rods of the radially inner layer and radially outer layer, which are directed towards one another. In this manner, a large surface area and/or a high material thickness is provided for joining the first and second conductor rod ends.

The welded joint can be configured as a fillet weld, butt weld or combination of weld types, depending in particular on the welding process. Furthermore, according to one embodiment, the overlap abutment of the first conductor rod ends and second conductor rod ends can be joined by electron beam welding.

According to one embodiment, a radial depth of the bending corresponds in each case to a radial distance between the radially inner layer and the radially outer layer of the conductor rods within the stator core. In this manner, the radial distance between the radially inner layer of conductor rods and the radially outer layer of conductor rods is bridged by the bending of the respective first conductor rod ends. According to one embodiment, the radial distance between the radially inner layer and the radially outer layer of the conductor rods can correspond to the radial thickness of a conductor rod. Further distances between the radially inner layer and the radially outer layer are also conceivable and can be freely selected by the mechanical design, configuration and/or orientation of the bending. According to one embodiment, the radial distance between the radially inner layer and the radially outer layer of the conductor rods can be selected depending on the thickness of the stator yoke, in particular the radial yoke thickness.

According to one embodiment, proceeding from the first conductor rod end, the conductor rods are each formed bent over a distance in the range from approximately 5% to approximately 25%, in some embodiments approximately 10% to approximately 20%, or approximately 12% to approximately 18%, of the entire length of the respective conductor rod. In this manner, a large part of the length of the respective conductor rod remains non-bent, which is particularly advantageous when handling the conductor rods.

According to one embodiment, the bending is configured as a double bend. In this manner, the radial distance between the radially inner layer and the radially outer layer of the conductor rods is bridged using a particularly cost-effective forming process. The bending can be configured as an opposite double bend. The respective angles of the conductor rod can amount to angles between 20° and 70°, in some embodiments between 30° and 60° or between 40° and 50°.

According to an alternative embodiment, the bending of the respective conductor rod ends can be formed as a double rounded bend. The bending can be configured as an opposite double rounded bend. In this manner, a bending with an essentially s-shaped cross-section can be provided. The bending angles of the bends can amount to between 20° and 70°, in some embodiments between 30° and 60° or between 40° and 50°.

According to one embodiment of the method, after being introduced, the first conductor rod ends that lie in the overlap with the second conductor rod ends are joined at the overlap abutment, in particular by laser beam welding. In this manner, a large surface area and/or a high material thickness is provided for joining the first and second conductor rod ends. The welded joint can be configured as a fillet weld, butt weld or combination of weld types, depending in particular on the welding process. Furthermore, according to one embodiment, the overlap abutment of the first conductor rod ends and second conductor rod ends can be joined by electron beam welding. In this manner, a welding process is provided that is highly economical and flexible in use.

According to one embodiment, the winding is configured to be torsionally rigid in such a manner that a torque acting on the stator core during operation of a radial flux double-rotor machine can be supported on the carrier element, in particular completely, via the torsionally rigid winding. In this manner, all other types of force support devices, in particular for the stator core, can be advantageously omitted.

According to one embodiment, the stator core is configured to guide a primarily radial magnetic flux. This is a so-called “yokeless” design of the stator core, which in particular avoids magnetic flux guidance in a circumferential or tangential direction. A magnetic return in the stator core is not required, which reduces weight and iron losses.

According to one embodiment, the stator core has a radial yoke thickness which is less than 30%, in some embodiments less than 20% or less than 10% of a total radial stator core thickness. In a so-called “yokeless” design, a mechanical connection of the stator teeth is nevertheless provided in this manner, but this is not electromagnetically necessary and no functionally relevant magnetic flux takes place. The term “yokeless” therefore refers in particular to the electromagnetic flux guidance of the stator core.

According to one embodiment, the radially inner layer and the radially outer layer of the winding each have the thickness of a single conductor rod end. This means that one phase of the winding is formed with the cross-section of a single conductor rod end. Such a winding design according to the invention is made possible, among other things, by the special design of the radial flux double-rotor machine, which prevents the current displacement to the surface that would otherwise occur in conductors by means of their magnetic symmetry. In this manner, comparatively thick conductor cross-sections are possible and a relatively even current distribution across the cross-section is still achieved. For example, the thickness of the conductor rod ends can be in the range of several millimeters. In particular, these can be rods with a square profile with edge lengths of several millimeters, for example in the range from 2 mm to 6 mm, in particular in the range from 3 mm to 5 mm. Other cross-sectional shapes are also possible.

According to one embodiment, the conductor rods are each twisted in accordance with the helical shape in such a manner that a cross-section of a conductor rod is the same at every point of the conductor in relation to a radial axis of the cross-section. In particular, this involves a torsion of a conductor rod end, especially a non-circular one, around the central axis of the stator or machine. Depending on the shape of the screw, the conductor rod ends can also be bent. The inner and outer layers are interlocked, i.e. twisted in opposite directions, twisted and possibly bent. In this manner, the orientation of a conductor rod is ideally oriented for force transmission with the stator core from a mechanical point of view at every point of the stator core, so that the respective conductor rod is loaded evenly over its length. In the resulting rod structure, the conductors receive predominantly tensile and compressive stresses when tangential force is applied. In this manner, load peaks and deformations of the conductor rod ends are avoided. In particular compared to a configuration with straight conductors parallel to the axis, the mechanical stresses can thus be significantly reduced.

According to one embodiment, the conductor rods of the radially inner and outer layers belonging to the same phase of the winding are each interconnected at the conductor rod ends, in particular via a radially arranged conductor rod piece and/or by means of a material connection. In addition to a conductor loop, this also creates a torsionally rigid rod-like structure, so that a high torque can be received by the winding when fixing an axially accessible winding end without causing unacceptably large deformations and/or stress states. Thus, the self-supporting configuration of the winding is only made possible by the winding material, for example copper, without additional support means or elements.

According to one embodiment, the stator core contains a laminated stator core with helical stator grooves corresponding to the course of the winding, wherein a single conductor rod is arranged in each stator groove of the laminated stator core. The winding or the self-supporting rod system formed with it is thus embedded in the laminated stator core. Analogous to the conductor rods of the winding, the stator grooves therefore change their tangential position depending on the axial position, resulting in the screw shape. The direction of the change in position follows the conductor rods, i.e. the center line of the radially outer grooves and the radially inner grooves also each describe a helical line whose turning directions are opposite.

In further embodiments, other manufacturing methods known to the skilled person for producing the stator core geometry according to the invention with the radially inner and outer stator grooves running in opposite helical directions would also be conceivable, in particular also additive manufacturing methods, such as sintering processes or the like.

According to one embodiment, only a single conductor rod end is disposed in each stator groove of the laminated stator core. As already explained in relation to the winding, the conductor rods of the inner and outer stator grooves are helically interlocked with each other by torsion around the center axis of the machine, so that the conductor ends of the inner and outer layers are guided towards each other. The conductor rods are conductively connected to each other at the conductor rod ends, in particular via a radially arranged conductor rod piece and/or by means of a material connection, for example by welding or brazing.

According to one embodiment, the conductively connected conductor rods of the inner and outer layers together form wave-shaped winding strands. The winding strands can be interconnected to form a rotating field-generating winding with a desired or customizable number of strands by means of appropriate interconnections known to the skilled person. The number of winding strands that can withstand the voltage results directly from the quotient of the number of slots in the numerator and a product of the number of strands and the number of parallel branches in the numerator. Advantageously, the number of parallel branches is selected as 1. In this case, the simplest possible connection of the winding is achieved.

According to one embodiment, the stator sheets of the laminated stator core each have the same recesses to form the stator grooves. The helical course of the stator grooves is provided by means of a mutually twisted stacking of the stator sheets. In this manner, the laminated stator core can be manufactured very economically, as the same punching die can be used for all parallel or stacked stator sheets. Accordingly, two adjacent stator sheets are slightly rotated relative to each other by a predetermined angle around the center axis, so that the recesses are arranged in an overlap to one another that corresponds to the helical line course.

According to an advantageous embodiment, the laminated stator core contains an inner partial package having radially inner stator grooves and an outer partial package having radially outer stator grooves. The stator sheets of the inner partial package are each configured to have the same geometry and the stator sheets of the outer partial package are each configured to have the same geometry. The stator sheets of the inner partial package and the stator sheets of the outer partial package are stacked in a manner twisted oppositely with regard to one another. In this manner, the opposing helical lines of the stator grooves can be produced with little manufacturing effort. Nevertheless, a very economical production method is still possible, as the same punching die can be used for all parallel or stacked stator sheets of the inner partial package and the same punching die can be used for all parallel or stacked stator sheets of the outer partial package. Accordingly, two adjacent stator sheets of the inner partial package are slightly rotated in a first direction relative to one another by a predetermined angle about the center axis and two adjacent stator sheets of the outer partial package are slightly rotated in a second, opposite direction relative to one another by a predetermined angle about the center axis. In this manner, the recesses of the stator sheets of the inner partial package and the recesses of the stator sheets of the outer partial package are arranged in an opposed overlap with respect to one another, which corresponds to the opposed helical line course.

According to a further embodiment, the stator sheets with recesses provided to form the stator grooves are each designed differently. The helical course of the stator grooves is provided by means of different distances between the recesses in the individual stator sheets. In this respect, an individually matching stator sheet shape is produced for each position of a stator sheet within the stack, wherein the individual geometries can also be repeated within the stack. In this case, production can be implemented using a beam cutting process, in particular a laser beam cutting process, which is more flexible in terms of shape compared to a punching process. Also feasible would be flexible stamping dies with variable geometry or, in the case of very large quantities, of course several individual stamping dies for each of the different stator plate shapes.

According to a further development, the recesses for radially inner and radially outer stator grooves are each integrated in a common stator sheet, wherein the oppositely helical course of the radially inner and radially outer stator grooves is provided by a continuous displacement of the inner and outer stator grooves with respect to one another from stator sheet to stator sheet. Here, too, an individually matching stator sheet shape is produced for each position of a stator sheet within the stack, wherein the individual geometries can also be repeated within the stack. In particular, flexible cutting processes, such as laser cutting, are also used for production here. The one-piece production of the inner and outer recesses that is possible in this way advantageously reduces the number of parts.

According to one embodiment, the stator sheets have straight, in particular punched, edges. A width of the recesses provided for the stator grooves is greater than the width of the conductor rods by an amount predetermined by the pitch of the helical shape of the course of the stator grooves and by the sheet thickness of the stator sheets. A clear width or continuous width of the stator grooves reduced by the bending between the recesses of the stator sheets thus essentially corresponds to the width of a conductor rod end. In practice, the continuous clear width of the stator groove is slightly greater than the width of the conductor rod end to provide the necessary clearance fit for introducing the conductor rod. The edge of a stator groove thus describes a staircase shape with the respective sheet thickness as steps on which the conductor rod end is evenly supported. In this manner, torque support is provided evenly over the entire thickness of the laminated stator core or over the entire length of the conductor rods accommodated in the laminated stator core.

According to one embodiment, an angle swept by each of the stator grooves is smaller than an angle swept by each of the conductor rod ends. The swept angle relates in each case to a rotation around the central axis of the stator. The difference in the swept angles is due to the fact that the conductor rods protrude axially beyond the stator core and are therefore longer than the stator grooves. As the helical shape also continues, this results in a larger swept angle. Said difference is provided to ensure sufficient accessibility of the winding ends for connecting, in particular welding, the conductor rod ends after introducing them into the stator grooves. Furthermore, this allows the winding to engage with the support device or its support element axially offset with respect to the stator core.

From the quotient of the swept angles, i.e. a ratio of the angle swept by the stator grooves to the angle swept by the conductor rods, a so-called pole coverage ratio can be defined for the laminated stator core.

According to one embodiment, the ratio of the angle swept by each of the stator grooves to the angle swept by each of the conductor rod ends is in a range between 0.6 and 0.8, in particular between 0.6 and 0.75, in some embodiments between 0.6 and 0.7. This ratio (degree of pole coverage) provides an optimum in this range between losses caused by current heat and torque utilization.

According to one embodiment, the support device has a support element in which support grooves corresponding to the helical arrangement of the conductor rod ends and engaging with the conductor rods are provided. In this manner, a form-fitting embedding of the conductor rods in the carrier element is provided to support the torque at the axial end. In some embodiments, there is engagement with all the conductor rods so that the torque support is transferred homogeneously or evenly over the entire rod structure of the winding.

In order to transmit the torque, the support element can be coupled to a mechanically fixed base of a radial flux double-rotor machine. One possible design provides through-holes for force-fitting fasteners such as screws, but of course form-fitting fasteners or a material-fitting connection would also be feasible.

According to one embodiment, the support grooves follow, at least in sections, the helical course of the twisted conductor rod ends. In particular, the support grooves have the same twisted shape as the conductor rod ends. For example, the support element is substantially annular in shape and has recesses on the inner and/or outer circumference, which are radially oriented and correspond to the course of the conductor rod ends.

According to one embodiment, the support device has a radially inner support element for engaging with the radially inner layer of the conductor rods and a radially outer support element for engaging with the radially outer layer of the conductor rods. In this embodiment, the support elements can be annular, with the inner support element having grooves or teeth on its outer circumference corresponding to the course of the inner layer of the conductor rods for form-fitting reception of the radially inner conductor rods and the outer support element having grooves or teeth on its inner circumference corresponding to the course of the radially outer layer of the conductor rods for form-fitting reception of the radially outer conductor rods. In particular, the grooves or teeth follow the respective helical course. Due to the arrangement on the inner or outer circumference, the recessed grooves are easily accessible for mechanical processing, which simplifies the production of the support elements.

According to one embodiment of a radial flux double-rotor machine, the support elements are fixed to the base and thus guide the torque to the fixed part of the electric machine. For this purpose, the support elements can be individually attached to the base, for example a housing, of the machine. Alternatively, or additionally, the inner and outer support elements can also be fastened together.

According to one embodiment of a stator, the support device contains a thermally conductive material, for example a metal, in some embodiments an aluminum alloy. In particular, both support elements can contain such a material. In addition to high mechanical strength, this also enables heat to be dissipated from the winding via the support device.

According to one embodiment of a corresponding radial flux double-rotor machine with a support device containing a thermally conductive material, the base also has a heat sink which is configured to absorb heat dissipated from the stator, in particular from the winding, via the support device. As a result, the support device has a high mechanical strength and at the same time ensures a good thermal connection between the winding and the heat sink. For example, the housing of the machine can serve as a heat sink. Alternatively, or additionally, the support device, for example the inner and outer support elements, can be in thermal contact with an actively cooled heat sink of the machine. In this manner, the current heat losses occurring in the winding or in the conductor rod ends can be effectively dissipated.

According to one embodiment of a radial flux double-rotor machine, a predetermined number of pool pairs are provided on both the first rotor and the second rotor. An angle swept by the conductor rod ends is designed to form a conductor loop for each pole of the rotors. The swept angle to be provided can therefore be calculated from the quotient of a whole revolution (2π or 360°) and twice the number of pole pairs.

According to one embodiment of the production process, the providing of the stator core comprises the production of a laminated stator core, wherein individual stator sheets, which have recesses for the formation of stator grooves, are stacked in a manner twisted oppositely with regard to one another. In this manner, the laminated stator core can be manufactured very economically, as the same punching die can be used for all parallel or stacked stator sheets. Accordingly, two adjacent stator sheets are slightly rotated relative to each other by a predetermined angle around the center axis, so that the recesses are arranged in an overlap to one another that corresponds to the helical line course. The individual stator sheets with such a geometry are advantageously produced by punching or laser cutting of individual laminations from electrical steel.

According to a further development of the method, the laminated stator core contains an inner partial package and an outer partial package, wherein all the stator sheets of the inner partial package are each configured with the same geometry and all the stator sheets of the outer partial package are each configured with an identical geometry, and wherein the stator sheets of the inner partial package for forming the inner stator grooves and the stator sheets of the outer partial package for forming the outer stator grooves are stacked in a manner twisted oppositely with respect to one another. In this case, all the sheets of the inner and outer packages can be configured with the same geometry, making the manufacturing process very economical. The same punching die can thus be used for all parallel or stacked stator sheets of the inner partial package and the same punching die can be used for all parallel or stacked stator sheets of the outer partial package. Two adjacent stator sheets of the inner partial package are twisted slightly in a first direction towards each other by a predetermined angle about the center axis and two adjacent stator sheets of the outer partial package are twisted slightly in a second direction towards each other by a predetermined angle about the center axis. In this manner, the recesses of the stator sheets of the inner partial package and the recesses of the stator sheets of the outer partial package are arranged in an opposed overlap with respect to one another, which corresponds to the opposite helical line course. In this manner, the opposing helical lines of the stator grooves can be produced with little manufacturing effort.

According to a further embodiment of the method, the laminated stator core has a plurality of differently shaped stator sheets, wherein the recesses for the inner and outer stator grooves are each integrated in a common stator sheet, and wherein the pitch of the helical line is achieved by continuously shifting the inner and outer stator grooves with respect to one another from stator sheet to stator sheet, in particular using a flexible punching or laser beam separation process. In this case, inner and outer stator grooves are integrated in a single stator sheet (lamination) and the helical shape of the stator grooves is created in each individual sheet by continuously shifting the recesses with respect to each other in the separation process, for example by means of a flexible punching process or a laser beam separation process. This has the advantage that with fewer parts, fewer production steps are required and the resulting stator sheet or the entire stator core has a higher mechanical strength.

In a further embodiment, the method further comprises the step of providing a support device which is configured for form-fitting engagement with the conductor rod ends at at least one axial end for torque support, and the step of bringing the support device into form-fitting engagement with the conductor rod ends at the at least one axial end at a position axially offset from the stator core.

According to one aspect, a stator produced in this way can furthermore be used to carry out a method for producing a radial flux double-rotor machine, comprising the further steps: Providing a mechanically fixable base and a support device which is configured for form-fitting engagement with the winding at the at least one axial end for torque support, and fastening the support device to the base.

The above embodiments and modifications may be combined with each other in any sensible way. In particular, all features of the stator can be transferred to the method for producing a stator, and vice versa. Furthermore, all features of the stator can be transferred to a corresponding radial flux double-rotor machine as well as to a vehicle axle having such a radial flux double-rotor machine and/or a vehicle having such a vehicle axle.

Further possible embodiments, further configurations and implementations of the invention also comprise combinations, not explicitly mentioned, of features of the invention described above or below with respect to the exemplary embodiment. In this respect, the skilled person will in particular also add individual aspects as improvements or additions to the respective basic form of the present invention.

### DESCRIPTION OF THE DRAWINGS

The present invention will be explained in more detail below using the exemplary embodiments shown in the schematic figures in the drawing. The figures show:

FIG. 1 an exploded view of a stator according to the invention with assembled stator core and support device;

FIG. 2 an exploded view of the stator according to FIG. 1;

FIG. 3 a side view of the stator according to FIG. 2 with assembled stator core and support device;

FIG. 4 a detailed view of a stator according to one embodiment;

FIGS. 5a-b detailed views of a bent conductor rod according to one embodiment;

FIG. 6 a schematic longitudinal sectional view of a stator;

FIG. 7 a schematic longitudinal sectional view of a radial flux double-rotor machine;

FIG. 8 an exploded view of a radial flux double-rotor machine according to one embodiment;

FIG. 9 an exploded view of a stator according to one embodiment;

FIG. 10 an exploded view of a radial flux double-rotor machine according to a further embodiment;

FIG. 11 a perspective view of the radial flux double-rotor machine according to FIG. 10 in the assembled state;

FIG. 12 a perspective detail view of a longitudinal sectional view of a radial flux double-rotor machine according to a further embodiment;

FIG. 13 an exploded view of a laminated stator core of a stator core;

FIG. 14 a schematic longitudinal sectional view of a stator groove;

FIG. 15 a perspective view of a winding;

FIG. 16 a plan view of a winding; and

FIG. 17 a flow diagram of a method for producing a stator.

The accompanying drawings are intended to provide a further understanding of embodiments of the invention. They illustrate embodiments and, in connection with the description, serve to explain principles and concepts of the invention.

Other embodiments and many of the advantages mentioned will be apparent with reference to the drawings. The elements shown in the drawings are not necessarily shown to scale with respect to each other.

In the figures of the drawing, the same elements, features and components, which have the same function and act in the same way, are each identified with the same reference signs, unless otherwise stated.

### DESCRIPTION OF EXEMPLARY EMBODIMENTS

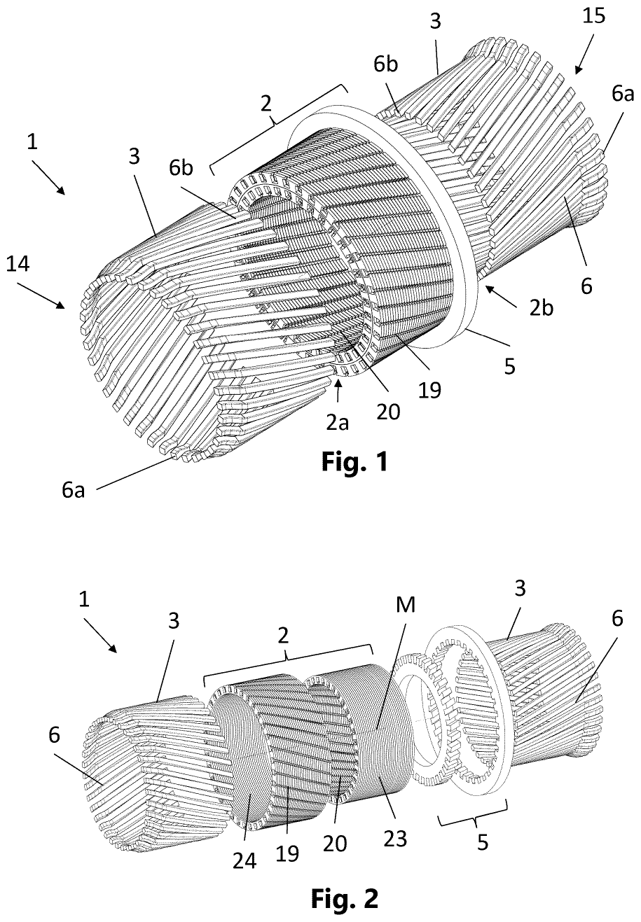

FIG. 1 shows an exploded view of a stator 1 according to the invention with an assembled stator core 2 and support device 5.

The stator 1 for a radial flux double-rotor machine 10, in particular for a wheel hub motor, has a stator core 2 and a winding 3 disposed in the stator core 2. The winding 3 is configured to be self-supporting for torque support of the stator 1, with the winding 3 protruding beyond the stator core 2 at at least one axial end 4.

The winding 3 is configured from interconnected conductor rods 6 and has a radially inner layer 15 of helically arranged conductor rods 6 and a radially outer layer 14 of oppositely helically arranged conductor rods 6. The conductor rods 6 are each configured to be bent at a first conductor rod end 6a and non-bent at a second conductor rod end 6b.

The exploded view of the stator 1 of FIG. 1 is intended to show the individual components of the stator 1 for the purpose of improved clarity. In this respect, for example, the conductor rods 6 of the winding 3 are shown divided into the radially inner layer 15 and radially outer layer 14.

The stator 1 also has a support device 5 that is axially offset from the stator core 2, which support device 5 is configured for form-fitting engagement with the winding 3 at at least one axial end 4 for torque support.

As shown in FIG. 1, the first conductor rod ends 6a of the conductor rods 6 of the radially outer layer 14 are arranged in such a manner that the bending is oriented radially inwards in each case. Furthermore, the first conductor rod ends 6a of the conductor rods 6 of the radially inner layer 15 are arranged in such a manner that the bending is oriented radially outwards in each case.

The conductor rods 6 of the radially outer layer 14 are received in outer stator grooves 19 and arranged with the first conductor rod end 6a at a first axial end 2a of the stator core 2. The helical shape of the conductor rods 6 of the radially outer layer 14 corresponds to the helical shape of the outer stator grooves 19.

The conductor rods 6 of the radially inner layer 15 are received in inner stator grooves 20 and arranged with the first conductor rod end 6 at a second axial end 2b of the stator core 2. The helical shape of the conductor rods 6 of the radially inner layer 15 corresponds to the helical shape of the inner stator grooves 20.

Furthermore, the first axial end 2a is arranged opposite to the second axial end 2b with respect to an axial center of the stator core 2.

In addition, in order to form conductor loops, the first conductor rod ends 6a of the conductor rods 6 of the radially outer layer 14 are joined to the second conductor rod ends 6b of the conductor rods 6 of the radially inner layer 15 at the first axial end 2a, and the first conductor rod ends 6a of the conductor rods 6 of the radially inner layer 15 are joined to the second conductor rod ends 6b of the conductor rods 6 of the radially outer layer 14 at the second axial end 2b.

FIG. 2 shows an exploded view of the stator 1 as shown in FIG. 1.

FIG. 2 shows the stator 1 according to the invention illustrated in FIG. 1, wherein the stator core 2 is divided into the inner partial package 23 and outer partial package 24 of stator sheets. In this view, the respective helical course of the conductor rods 6 of the radially inner layer 15 and radially outer layer 14 and stator grooves 19, 20 is clearly shown. Furthermore, as shown in FIG. 2, all components are arranged coaxially around the center axis M.

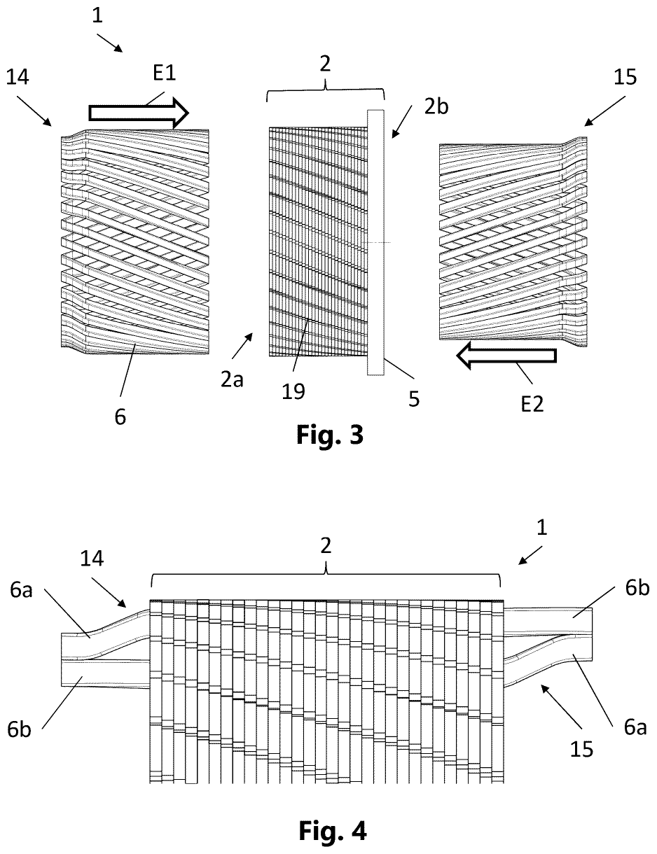

FIG. 3 shows a side view of the stator 1 according to FIG. 1 with assembled stator core 2 and support device 5.

The conductor rods 6 of the radially inner layer 15 and the conductor rods 6 of the radially outer layer 14 of the winding 3 are each shown axially offset in the opposite direction to the stator core 2 and the support device 5.

By means of FIG. 3 there can be illustrated the method for producing a stator 1 for a radial flux double-rotor machine 10.

The method comprises the step of providing a stator core 2 with radially outer stator grooves 19 each describing a helical line and radially inner stator grooves 20 each describing a helical line with the opposite turning direction (not shown or concealed).

Furthermore, the method includes the step of providing individual conductor rods 6, which are bent at a first conductor rod end 6a and non-bent at a second conductor rod end 6b.

In addition, the method comprises the step of introducing the individual conductor rods 6 of the radially outer layer 14 at a first axial end 2a of the stator core 2 into the radially outer stator grooves 19 in such a manner that at the first axial end 2a the bending of the first conductor rod ends 6a of the conductor rods 6 of the radially outer layer 14 is oriented radially inwards. In this respect, the introducing direction E1 shows the axial direction in which the conductor rods 6 of the radially outer layer 14 are introduced into the stator grooves 19 of the stator core 2.

Furthermore, the method comprises the step of introducing the individual conductor rods 6 of the radially inner layer 15 at a second axial end 2b of the stator core 2 into the radially inner stator grooves 20 in such a manner that at the second axial end 2b the bending of the first conductor rod ends 6a of the conductor rods 6 of the radially inner layer 15 is oriented radially outwards. In this respect, the introducing direction E2 shows the axial direction in which the conductor rods 6 of the radially inner layer 15 are introduced into the stator grooves 20 of the stator core 2.

Furthermore, the method comprises the step of joining the conductor rods 6 inserted into the inner and outer stator grooves 19, 20 at the conductor rod ends 6a, 6b in order to form conductor loops. In this respect, the first conductor rod ends 6a of the conductor rods 6 of the radially outer layer 14 are joined to the second conductor rod ends 6b of the conductor rods 6 of the radially inner layer 15 at the first axial end 2a of the stator core 2 and the first conductor rod ends 6a of the conductor rods 6 of the radially inner layer 15 are joined to the second conductor rod ends 6b of the conductor rods 6 of the radially outer layer 14 at the second axial end 2b of the stator core 2.

FIG. 4 shows a detailed view of a stator 1 according to one embodiment.

In order to form conductor loops, the first conductor rod ends 6a of the conductor rods 6 of the radially outer layer 14 are joined to the second conductor rod ends 6b of the conductor rods 6 of the radially inner layer 15. Accordingly, and as shown in FIG. 4, the first conductor rod ends 6a of the conductor rods 6 of the radially inner layer 15 are joined to the second conductor rod ends 6b of the conductor rods 6 of the radially outer layer 15 and the first conductor rod ends 6a of the conductor rods 6 of the radially outer layer 14 are joined to the second conductor rod ends 6b of the conductor rods 6 of the radially outer layer 15.

The respective first conductor rod ends 6a are joined to the respective second conductor rod ends 6b at the overlap abutment. As shown in FIG. 4, the conductor rods 6 of the radially inner layer 15 and radially outer layer 14 each form overlap abutments on opposite axial ends 2a, 2b. The respective overlap abutment can be joined in particular by laser beam welding.

Furthermore, it can be seen that a radial depth of the bending corresponds in each case to a radial distance between the radially inner layer 15 and the radially outer layer 14 of the conductor rods 6 within the stator core 2.

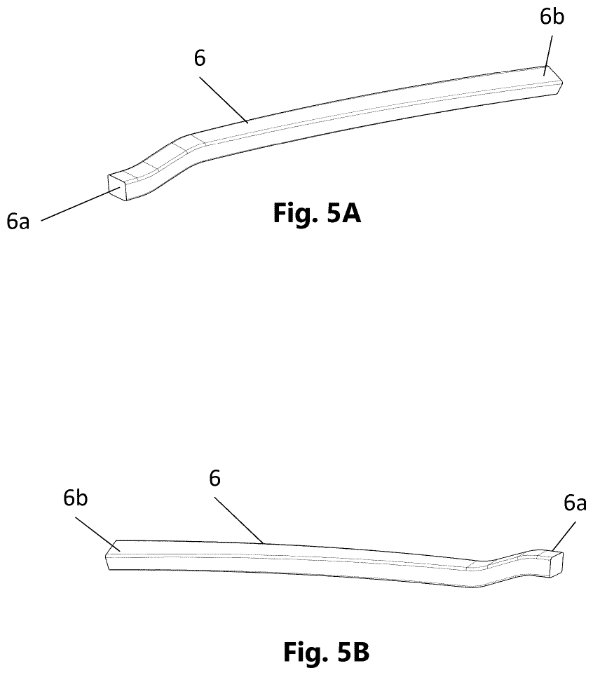

FIGS. 5a and 5b show detailed views of a bent conductor rod end 6 according to one embodiment.

Proceeding from the first conductor rod end 6a, the conductor rods 6 are each bent over a distance in the range of approximately 5% to approximately 25%, in some embodiments approximately 10% to approximately 20% or approximately 12% to approximately 18%, of the entire length of the respective conductor rod 6. Proceeding from the first conductor rod end 6a, the conductor rods 6 shown in FIG. 5A and FIG. 5B are bent over a distance of approximately 15% of the entire length of the conductor rod 6.

The bending of the conductor rod ends 6a of the conductor rods 6 is configured as a double-rounded bend. Furthermore, the respective conductor rod 6 shown is rotated, in particular twisted, along its longitudinal axis.

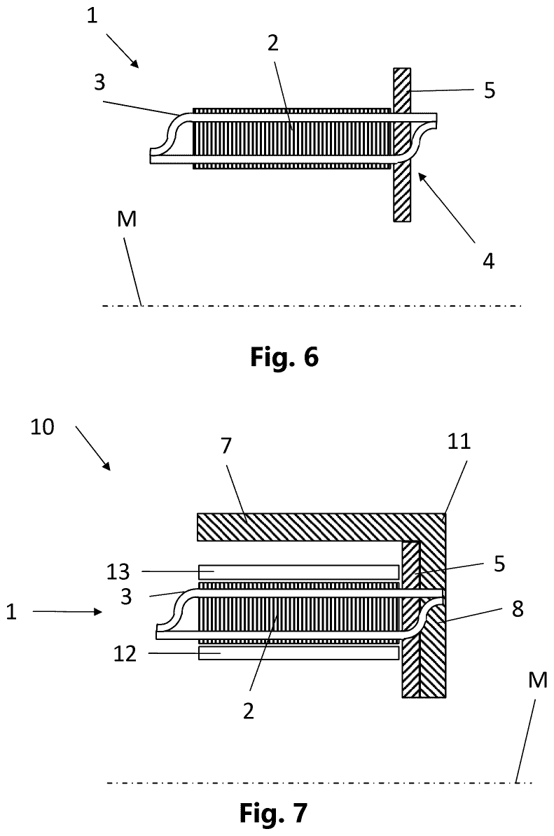

FIG. 6 shows a schematic longitudinal sectional view of a stator 1.

In this respect what is concerned here is a schematic diagram of a stator 1 for a radial flux double-rotor machine 10 (see, here, for example, FIG. 1), in particular for a wheel hub motor. The stator has a stator core 2, a winding 3 and a support device 5. The stator core 2, the winding 3 and the support device 5 are rotationally symmetrical about the center axis M indicated.

The winding 3 is configured to be self-supporting for torque support of the stator 1 and protrudes beyond the stator core 2 at at least one axial end 4. The support device 5 is arranged axially offset to the stator core 2 and is form-fittingly connected to the winding 3 at at least one axial end 4 for torque support. In this manner, a torque applied to the stator core 2 during operation of a radial flux double-rotor machine 10 can be supported on the support device 5 by means of the self-supporting winding 3.

The winding 3 contains a conductor material with low electrical resistance, for example copper. The stator core 2 is for example made of a soft magnetic material for magnetic flux guidance. The support device 5 may contain a thermally conductive material, for example an aluminum alloy. The winding 3 is obviously electrically insulated.

FIG. 7 shows a schematic longitudinal sectional view of a radial flux double-rotor machine 10.

This is also a purely illustrative schematic diagram. Accordingly, in addition to the stator 1 as shown in FIG. 6, the radial flux double-rotor machine 10 has a mechanically fixed base 11, a first rotor 12 and a second rotor 13. The stator core 2, the winding 3, the support device 5, the base 11, the first rotor 12 and the second rotor 13 are also rotationally symmetrical about the center axis M indicated.

The winding 3 is configured to be self-supporting for torque support of the stator 1 and protrudes beyond the stator core 2 at at least one axial end 4 and is supported on the base 11 via the support device 5. For this purpose, the support device 5 is arranged axially offset to the stator core 2 and is connected in a form-fitting manner to the winding 3 at at least one axial end 4 for torque support. The support device 5 is in turn attached to the base 11 so that the torque can be supported on the base 11 via the support device 5.

The first rotor 12 is arranged radially inside the stator core 2 and the second rotor 13 is arranged radially outside the stator core 2. The base 11 can, for example, be configured as the housing of the machine and, purely for illustrative purposes, comprises a structure that is configured as L-shaped in the longitudinal sectional view, which is shown with two limbs 7, 8. The illustration is not to be understood as conclusive, rather the base 11 can have further components and/or structural portions. The first limb 8 extends substantially radially, the second limb 7 substantially axially with the greatest distance from the center axis M.

Purely schematically, the support device 5 is shown running radially in one piece, but it can also be provided in several parts and/or with a different geometry configured for form-fitting with the winding 3. The overlap of the winding 3 shown with the base 11 is purely for illustrative schematic purposes and does not indicate a direct connection. The winding 3 is for example connected to the base 11 for torque support via the support device 5.

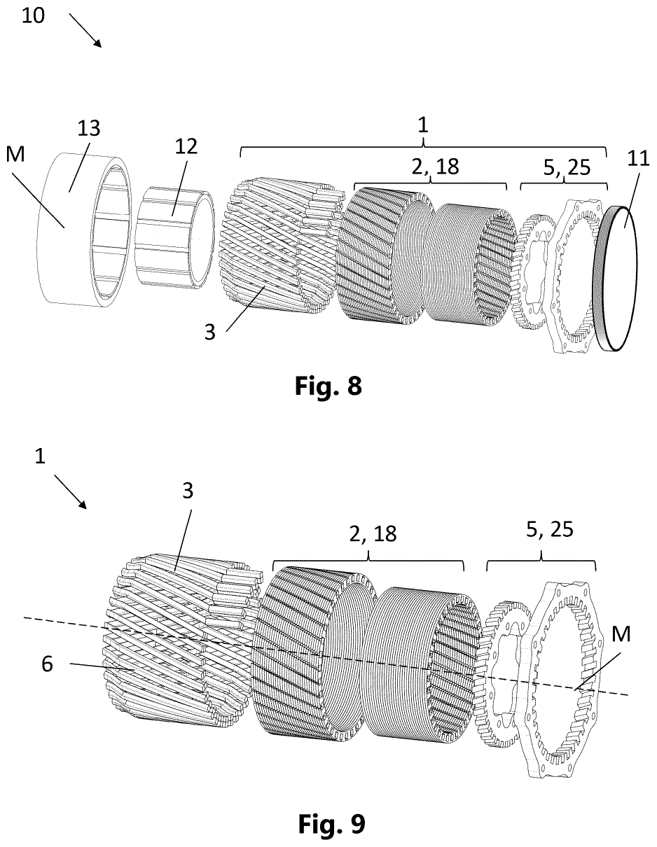

FIG. 8 shows an exploded view of a radial flux double-rotor machine 10 according to one embodiment.

In addition to the components of the stator 1, the radial flux double-rotor machine 10 comprises a first rotor 12, a second rotor 13 and a base 11. The first rotor 12 is arranged radially within the stator core 2 and the second rotor 13 is arranged radially outside the stator core 2. The rotors 12, 13 are for example made of a soft magnetic solid material and are equipped with permanent magnets, so-called surface magnets, as poles on the respective surface facing the stator core 2. In other embodiments, other rotors known to the skilled person can also be used, for example with buried magnets, short-circuit rotors or electrically excited rotors.

The base 11 is shown here merely schematically for the sake of clarity. As already described in the description of FIG. 7, the base 11 is attached to the support device 5 when mounted. The base 11 is mechanically fixed in relation to a reference system, for example a carrier of a vehicle axle.

FIG. 9 shows an exploded view of a stator 1 according to one embodiment.

The stator 1 has a winding 3, a stator core 2 and a support device 5, wherein an advantageous exemplary design of these components is shown here in more detail in perspective.

The winding 3 is constructed from an inner and outer layer having a plurality of conductor rods 6 which are connected together in the manner of a rod structure. The conductor rod 6 in the inner and outer layers 14, 15 are oppositely helically arranged conductor rods.

The thickness of the inner and outer layers 14, 15 can each correspond to the thickness of a conductor rod 6. This means that the winding 3 is formed by a single conductor layer forming the conductor loop with a comparatively large cross-section in the form of a conductor rod 6 in each case.

Due to the rod structure formed with the conductor rods 6, the winding 3 is torsionally rigid and thus self-supporting for torque support.

Accordingly, the conductor rods 6 form wave-shaped winding strands and can be interconnected to form a rotary field-generating winding of any number of strands by means of corresponding interconnections known to the skilled person and therefore not described further, such as delta connection, star connection or the like.

In the embodiment shown, the stator core 2 and the support device 5 are each made up of two components, for example. To assemble the stator 1, the winding 3, the stator core 2 and the support device 5 are arranged nested inside each other. After assembly, the components are oriented coaxially to each other on the common center axis M. The exemplary two-part support device 5 is arranged axially offset from the other components and forms the radially innermost and outer-most component of the stator 1. It consists of an inner ring and an outer ring, each of which is formed with grooves for form-fitting engagement with the conductor rods 6.

The exemplary two-part stator core 2 is formed with two helically twisted laminated stator cores 18, which will be discussed in more detail with reference to FIG. 13.

In further embodiments, the stator core 2 and the support device 5 can each also be configured in one piece or with more than two parts.

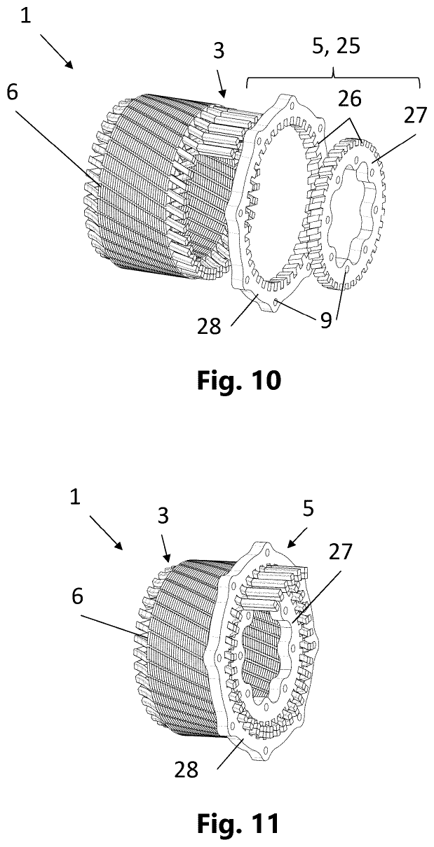

FIG. 10 shows an exploded view of a stator 1 according to a further embodiment.

The stator 1 here has substantially the same components as configured with reference to FIG. 9. On the left-hand side of FIG. 10, the stator core 2 and the winding 3 are shown in the assembled state. Furthermore, the first rotor 12 can be arranged radially inside the stator core 2 and the second rotor 13 can be arranged radially outside the stator core 2.

The support device 5 shown on the right is also configured in two parts and differs in the design of the respective ring-shaped inner support element 27 and outer support element 28. The support elements 27, 28 are equipped here with support grooves 26. These are provided on the inner circumference of the outer support element 28 and on the outer circumference of the inner support element 27 for engagement with the conductor rods 6 of the winding 3.

For this purpose, the support grooves 26 are axially angled in accordance with the helical shape of the conductor rods 6 or their pitch, so that they can be brought into engagement with the conductor rods 6 of the winding 3.

The support elements 27, 28 are in some embodiments made of a conductive metal, for example of an aluminum alloy. The two-part configuration of the support elements 27, 28 makes it possible for the support grooves 26 to be easily accessible during manufacture for mechanical or machining processing.

The inner support element 27 and the outer support element 28 are each provided with several holes 9 all around for fastening to the base 11. In this example, the holes 9 are each arranged evenly distributed around the circumference along a bolt circle. The individual holes 9 are located slightly outside the main body of the support elements and the support elements 27, 28 therefore form a star shape on the circumference facing away from the winding. Other distributions of the holes 9 as well as other types of fastening means for the connection to the base 11 are obviously feasible.

FIG. 11 shows a perspective view of a stator 1 as shown in FIG. 10 in the assembled state.

The support device 5 is fastened via the respective holes 9, for example in a machine housing as a base 11, and thus guides the torque to the mechanically fixed part of the radial flux double-rotor machine 10. In this manner, the torque generated by the radial flux double-rotor machine 10 can be effectively supported. The fastening of the support device 5 is realized via corresponding fastening means, for example screws.

The conductor rods 6 of the winding 3 extend axially on both sides to the outside of the stator core 2 and the first and second rotors 12, 13. The helically arranged conductor rods 6 of the radially inner layer 15 and outer layer 14 are each joined together outside the stator core 2.

The support elements 27, 28 are shown here in engagement with the conductor rods 6 of the winding 3. It is evident that a conductor rod 6 is disposed in each support groove 26, so that all conductor rods 6 are form-fittingly coupled to the support device 5. Thus, a torque supported via the winding 3 can be supported via the support device 5 on the base 11 attached to the holes 9.

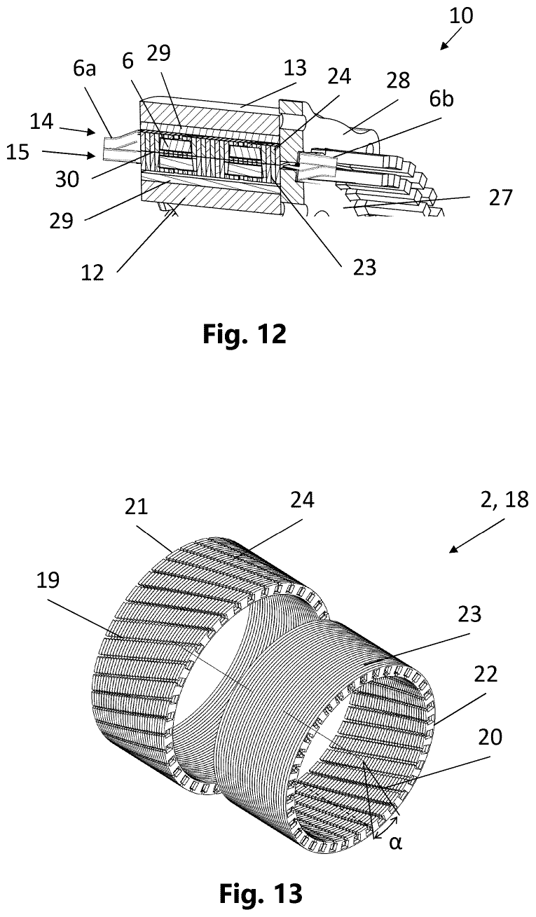

FIG. 12 shows a perspective detail view of a longitudinal sectional view of a radial flux double-rotor machine 10 according to a further embodiment;

This embodiment corresponds substantially to the assembly of a radial flux double-rotor machine 10 according to FIG. 8, the components of which are discussed in more detail below.

The stator core 2 has an inner partial package 23 and an outer partial package 24. The partial packages 23, 24 extend in a ring between the first and second rotor 12, 13. Due to the sectional view, it is also possible to see the inner and outer layers 14, 15 of the conductor rods 6 extending within the partial packages 23, 24. Furthermore, it is also evident that the conductor rods 6 are each configured to be bent at a first conductor rod end 6a and non-bent at a second conductor rod end 6b. In this respect, the first conductor rod ends 6a of the conductor rods 6 of the radially outer layer 14 are arranged in such a manner that the bending is oriented radially inwards in each case, and the first conductor rod ends 6a of the conductor rods 6 of the radially inner layer 15 are arranged in such a manner that the bending is oriented radially outwards in each case.

The radial flux double-rotor machine 10 shown is a so-called “yokeless” design in which the yoke between two teeth is not in the functionally relevant magnetic flux. Although there is a stator yoke 30 between the conductor rods 6, this only serves to mechanically hold the laminated stator core 18 together. A radial yoke thickness can be designed to be correspondingly thin, which in the embodiment shown, for example, is approximately 10% of the total radial stator thickness. The comparatively low yoke thickness also reduces undesirable magnetic leakage flux in the yoke. In further embodiments, the radial yoke thickness can be less than 30%, in some embodiments less than 20% or less than 10% of the total radial stator thickness for this purpose.

The support device 5 also has here an inner support element 27 and an outer support element 28. The support elements 27, 28 are arranged here in a clearly recognizable axial offset relative to the stator 5 and the rotors 12, 13. Furthermore, the form-fitting engagement of the support elements 27, 28 with the conductor rods 6 of the inner and outer layers 14, 15 is recognizable at least in sections.

Furthermore, it can be clearly seen in the embodiment shown that the first conductor rod ends 6a are joined to the second conductor rod ends 6b at the overlap abutment. The connection is for example implemented as a material-locking connection, for example by laser beam welding.

The surface magnets 29 of the rotors 12, 13 can also be seen in the section. The first rotor 12 has several permanent magnets 29 mounted on its outer circumferential surface. The second rotor 13 has several permanent magnets 29 mounted on its inner circumferential surface.

A particularly advantageous embodiment results if the rotors are configured from soft magnetic solid material and with surface-mounted permanent magnets. In this design, the rotors can be manufactured very cost-effectively and a high degree of efficiency can be achieved.

FIG. 13 shows an exploded view of the laminated stator core 18 of the stator core 2.

As already mentioned, the laminated stator core 18 of the stator core 2 has an inner partial package 23 and an outer partial package 24. This serves to simplify the production of the stator grooves 19, 20, which are twisted in opposite directions with respect to one another, with the inner and outer stator sheets 21, 22 stacked in the same twisted position and provided with recesses at the same points.

In further embodiments, the stator sheets can also be configured in one piece, so that a plurality of differently shaped stator sheets with differently arranged recesses are provided and stacked in the order required to form the stator grooves. In still further embodiments, completely one-piece stator cores 2 are also feasible, which, for example, can be additively manufactured.

In the two-part design shown, the inner diameter of the outer partial package 24 is almost the same as the outer diameter of the inner partial package 23. This makes it possible to arrange the inner partial package 23 coaxially within the outer partial package 24.

The partial packages 23, 24 are made up of individual annular stator sheets 21, 22 stacked on top of each other. The stator sheets 21 of the outer partial package 24 are produced with recesses positioned distributed around the outer circumference to form the outer stator grooves 19. The stator sheets 22 of the inner partial package 23 are manufactured with recesses positioned distributed around the inner circumference to form the inner stator grooves 20. For example, manufacturing such stator sheets by punching is advantageous due to the edge quality and very low manufacturing costs.

The inner and outer stator grooves 19, 20 describe opposing helical lines with the same pitch, which are characterized by the drawn swept angle of the stator grooves a. The swept angle of the stator grooves a can be defined from the angle between the position of the same stator groove on one axial side of the stator core 2 and on the other axial side of the stator core 2 in relation to the center axis M.

The stator grooves 19, 20 are exemplarily formed here as T-slots with a rectangular recess with a tapered opening. These are intended in particular for the form-fitting accommodation of conductor rod ends with a rectangular cross-section. The geometry of the recesses or stator grooves can, obviously, be adapted to the conductor geometry. Other cross-sectional shapes would also be feasible.

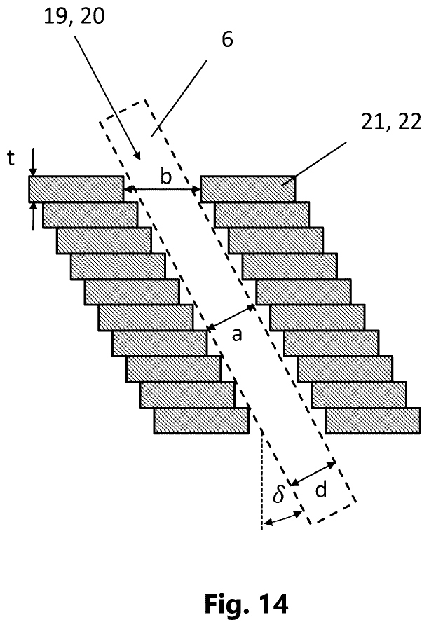

FIG. 14 shows a schematic longitudinal sectional view of a stator groove 19, 20.

The usable or continuous clear width a of the stator grooves 19, 20 within the laminated stator core 18 is substantially equal to the width of the conductor rods 6 accommodated within the stator core 2.

The stator sheets 21, 22 have straight, in particular punched, edges. Due to the offset of the metal sheets with respect to each other, the width b of the recesses provided for the stator grooves 19, 20 is greater than the width d of the conductor rods 6 by an amount predetermined by the pitch δ of the screw shape of the course and the sheet thickness t.

In FIG. 14, a conductor rod 6 is schematically indicated with dashed lines in the stator groove 19, 20, wherein, in order to provide a clearance fit, the continuous clear width a of the stator groove 19, 20 is slightly larger than the width d of the conductor rod 6 and the width a of the recess in the stator sheet 21, 22 is, in turn, considerably larger than the clear width b.

The sheet thickness t and the setting angle & of the pitch of the groove course represent a noticeable influencing factor for the difference between the width b of the recess and the clear width a of the usable passage within the groove in the case of straight, for example punched, sheet edges. The difference arises because the pitch angle on the one hand and the stepped nature of the laminated core on the other must be balanced out.

In this case, a minimum size of the width a of the recess for the limit case of infinitely thin sheets, i.e. a pure consideration of the pitch angle δ of the conductor rod, would be

b=1/cos(δ)*d.

In order to compensate for the actual sheet thickness on the one hand and to provide a clearance fit that allows the conductor rods to be introduced on the other, the width b of the recess is actually even greater.

The width b of the recesses according to FIG. 9 is dimensioned such that a clear width a of the stator grooves 19, 20 reduced by the offset between the recesses f the stator sheets forms a predetermined clearance fit with the width d of a conductor rod 6 to be introduced into the stator groove, but the contact is still close enough to serve for evenly distributed power transmission or torque support between the laminated stator core and the winding. Such a dimensioning is made possible, among other things, by the fact that on the one hand each stator sheet is formed with the same high edge quality and rotated with the same offset, and on the other hand only a single conductor rod 6 is disposed in each stator groove 19, 20, the dimensions of which are constant.

In particular, in the embodiment shown, the conductor rod 6 is a rectangular rod with an edge length or width of several millimeters, for example in the range from 2 mm to 6 mm, in particular in the range from 3 mm to 5 mm. For example, it can be a rectangular profile measuring 5 mm×3 mm.

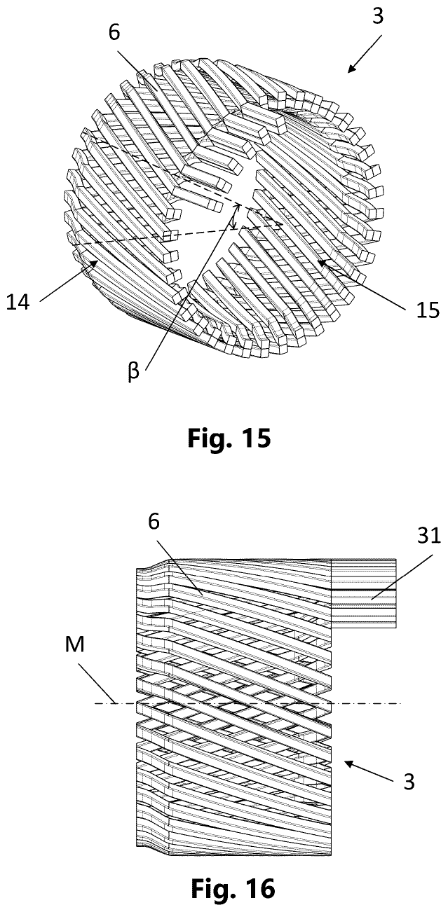

FIG. 15 shows a perspective view of a winding 3.

The winding 3 is constructed of said conductor rods 6, which run helically along the center axis M. For this purpose, the conductor rods 6 are not only arranged in an interlocked manner, but are also twisted in accordance with the helical line course.

The swept angle β of the conductor rods 6 identifies the angle between the start and end of a conductor rod 6 relative to the center axis M. Since the pitch of the helical line of the conductor rods 6 is equal to the pitch of the helical line of the stator grooves 19, 20, but the conductor rods 6 are longer than the stator grooves, a ratio of the respective swept angles a and B can be formed to characterize the geometric ratios, which is also referred to as the degree of pole coverage. In order to provide an optimum between magnetic losses and torque utilization of a radial flux double-rotor machine, this ratio is for example in a range between 0.6 and 0.75.

The opposed rotation and torsion of the inner and outer radially inner layers 14, 15 of conductor rods 6 can also be seen here. The torsion is configured in such a manner that the cross-section in relation to a radial line through the center of the conductor rod is always the same at every point of the conductor rod, which is also referred to as 2.5 D geometry. Thus, the conductor rod ends of the inner and outer layers 14, 15 are arranged one above the other in the same orientation. The conductor rods 6 of the radially inner and outer layers 14, 15 can thus be conductively connected in a simple manner, in this case by way of example the first and second conductor rod ends 6a, 6b are joined.

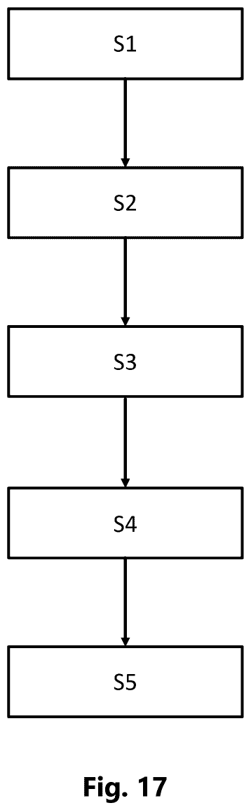

It should be noted that the winding shown here is not manufactured individually, but always in combination with the stator core 2, which will be discussed in more detail with reference to FIG. 17.

FIG. 16 shows a plan view of a winding 3.

This view clearly shows the exact radial alignment of the conductor rods 6 at every point of the helical course thereof, which is aligned in the area of the center axis M in the perspective shown. The first and second conductor rod ends 6a, 6b each form the connection point between the inner and outer radially inner layer 14, 15.

In the embodiment shown, the winding 3 has a total of twelve connection contacts 31 as an example. In the case of three-phase connection, three-phase operation can be provided. However, winding 3 can be adapted in a manner known in the art to other connections to form a rotating field-generating winding with any number of strands.

An FEM simulation of a winding 3 under load, essentially with the winding geometry shown in FIG. 15, clearly showed that the stresses within the winding 3 are very favorably distributed homogeneously due to the helical geometry.

The conductor rod ends 6a, 6b were defined in the FEM simulation by a swept angle of the conductor rods β>0, i.e. helically arranged or formed in a correspondingly twisted manner. At the axial end at which the support device engages, a maximum torque of the correspondingly dimensioned radial flux double-rotor machine 10 was applied, wherein in the case of a rectangular profile of the conductor rods 6 of 5 mm×3 mm, for example, this can be around 5000 Nm. There is barely any deformation to be seen, even with a significant exaggeration. Due to this configuration, stress peaks and thus also deformation are significantly reduced.

Due to the rod-like structure, a high torque can thus be received by the winding 3 in a self-supporting manner when fixing an axially accessible winding end without causing unacceptably large deformations and/or stress states. This is in particular due to the fact that in the rod structure, the conductor rods 6 primarily absorb tensile and compressive stresses when subjected to tangential force.

Compared to designs with straight conductors, parallel to the axis, the mechanical stresses can thus be significantly reduced.

In an FEM comparative model with a straight design and purely axial course of the conductor rods 6 under load, a stress curve concentrated on one side and a strong deformation of the conductor rods 6 with large deflection on the other side resulting from the locally high stress can be recognized due to the straight design and the axial course of the conductor rods 6. What is concerned here is a much greater deformation than in winding 3 with helical geometry, which clearly shows the effect of the different structural arrangements on the torsional stiffness.

FIG. 17 shows a flow diagram of a method for producing a stator 1.

The method comprises a first step of providing S1 a stator core 2 with radially outer stator grooves 19 each describing a helical line and radially inner stator grooves 20 each describing a helical line with an opposite turning direction.

Furthermore, the method comprises a second step of providing S2 individual conductor rods 6, which are bent at a first conductor rod end 6a and non-bent at a second conductor rod end 6b.

A further step relates to introducing S3 the individual conductor rods 6 at a first axial end 2a of the stator core 2 into the radially outer stator grooves 19, such that at the first axial end 2a the bending of the first conductor rod ends 6a of the conductor rods 6 of the radially outer layer 14 is oriented radially inwards.

A further step relates to introducing S4 the individual conductor rods 6 at a second axial end 2b of the stator core 2 into the radially inner stator grooves 20, such that at the second axial end 2b the bending of the first conductor rod ends 6a of the conductor rods 6 of the radially inner layer 15 is oriented radially outwards.

Furthermore, the method comprises a step of joining S5 the conductor rods 6 introduced into the inner and outer stator grooves 19, 20 at the conductor rod ends 6a, 6b to form conductor loops, wherein at the first axial end 2a of the stator core 2, the first conductor rod ends 6a of the conductor rods 6 of the radially outer layer 14 are joined to the second conductor rod ends 6b of the conductor rods 6 of the radially inner layer 15 in each case, and at the second axial end 2b of the stator core 2, the first conductor rod ends 6a of the conductor rods 6 of the radially inner layer 15 are joined to the second conductor rod ends 6b of the conductor rods 6 of the radially outer layer 14 in each case.

Furthermore, the method may comprise a step after introducing, wherein the first conductor rod ends 6a overlap with the second conductor rod ends 6b and are joined at the overlap abutment during joining, in particular by laser beam welding.

Although the present invention has been fully described above on the basis of preferred exemplary embodiments, the present invention is not limited thereto, but may be modified in a variety of ways.

1. A stator for a radial flux double-rotor machine, comprising:
a stator core;
a winding disposed in the stator core which winding is configured to be self-supporting for torque support of the stator, wherein the winding protrudes beyond the stator core at at least one axial end;
a support device arranged axially offset with respect to the stator core, which is configured for form-fitting engagement with the winding at the at least one axial end for torque support;
wherein the winding is formed from interconnected conductor rods and has a radially inner layer of helically arranged conductor rods and a radially outer layer of oppositely helically arranged conductor rods,
wherein the conductor rods are each configured to be bent at a first conductor rod end and non-bent at a second conductor rod end,
wherein the first conductor rod ends of the conductor rods of the radially outer layer are arranged in such a manner that the bending is oriented radially inwards in each case, and the first conductor rod ends of the conductor rods of the radially inner layer are arranged in such a manner that the bending is oriented radially outwards in each case.

2. The stator according to claim 1, wherein, in order to form conductor loops, the first conductor rod ends of the conductor rods of the radially outer layer are each joined to the second conductor rod ends of the conductor rods of the radially inner layer and the first conductor rod ends of the conductor rods of the radially inner layer are each joined to the second conductor rod ends of the conductor rods of the radially outer layer.

3. The stator according to claim 2,
wherein the first conductor rod ends are joined to the second conductor rod ends in an overlap joint.

4. The stator of claim 3, wherein the first conductor rod ends and the second conductor rod ends are joined by laser beam welding.

5. The stator according to claim 1,
wherein the conductor rods of the radially outer layer are received in outer stator grooves and arranged with the first conductor rod end at a first axial end of the stator core, and
the conductor rods of the radially inner layer are received in inner stator grooves and are arranged with the first conductor rod end at a second axial end of the stator core,
wherein, in order to form the conductor loops at the first axial end, the first conductor rod ends of the conductor rods of the radially outer layer are each joined to the second conductor rod ends of the conductor rods of the radially inner layer, and
at the second axial end, the first conductor rod ends of the conductor rods of the radially inner layer are each joined to the second conductor rod ends of the conductor rods of the radially outer layer.

6. The stator according to claim 2,
wherein the first conductor rod ends are joined to the second conductor rod ends in an overlap abutmet.

7. The stator of claim 6, wherein the first conductor rod ends and the second conductor rod ends are joined at the overlap abutment by laser beam welding.

8. The stator according to claim 1, wherein a radial depth of the bending corresponds to a radial distance between the radially inner layer and the radially outer layer of the conductor rods within the stator core.

9. The stator according to claim 1,
wherein the conductor rods, starting from the first conductor rod end, are each formed to be bent over a distance in the range from approximately 5% to approximately 25% of the entire length of the respective conductor rod.

10. The stator according to claim 1, wherein the bending is configured as a double bend.

11. The stator according to claim 1, wherein the stator is configured for a wheel hub motor.

12. A method for producing a stator for a radial flux double-rotor machine comprising the steps of:
providing a stator core having radially outer stator grooves each describing a helical line and radially inner stator grooves each describing a helical line with the opposite turning direction;
providing individual conductor rods which are configured to be bent at a first conductor rod end and which are configured to be non-bent at a second conductor rod end;
introducing the individual conductor rods at a first axial end of the stator core into the radially outer stator grooves in such a manner that at the first axial end the bending of the first conductor rod ends of the conductor rods of the radially outer layer is oriented radially inwards;
introducing the individual conductor rods at a second axial end of the stator core into the radially inner stator grooves in such a manner that at the second axial end the bending of the first conductor rod ends of the conductor rods of the radially inner layer is oriented radially outwards; and
joining the conductor rods introduced into the inner and outer stator grooves at the conductor rod ends in order to form conductor loops, where-in at the first axial end of the stator core the first conductor rod ends of the conductor rods of the radially outer layer are each joined to the second conductor rod ends of the conductor rods of the radially inner layer and at the second axial end of the stator core the first conductor rod ends of the conductor rods of the radially inner layer are each joined to the second conductor rod ends of the conductor rods of the radially outer layer.

13. The method of claim 12,
wherein after being introduced, the first conductor rod ends lie in overlap with the second conductor rod ends and, during joining, they are joined at the overlap abutment.

14. The method of claim 13, wherein the first conductor rod ends and the second conductor rod ends are joined at the overlap abutment by laser beam welding.

15. A radial flux double-rotor machine, comprising:
a stator comprising:
a stator core,
a winding disposed in the stator core, which winding is configured to be self-supporting for torque support of the stator, wherein the winding protrudes beyond the stator core at at least one axial end,
a support device arranged axially offset with respect to the stator core, which is configured for form-fitting engagement with the winding at the at least one axial end for torque support,
wherein the winding is formed from interconnected conductor rods and has a radially inner layer of helically arranged conductor rods and a radially outer layer of oppositely helically arranged conductor rods,
wherein the conductor rods are each configured to be bent at a first conductor rod end and non-bent at a second conductor rod end,
wherein the first conductor rod ends of the conductor rods of the radially outer layer are arranged in such a manner that the bending is oriented radially inwards in each case, and the first conductor rod ends of the conductor rods of the radially inner layer are arranged in such a manner that the bending is oriented radially outwards in each case;
a first rotor arranged radially inside the stator core of the stator; and
a second rotor arranged radially outside the stator core of the stator.

16. The radial flux double-rotor machine of claim 15, wherein the radial flux double-rotor machine is configured for a wheel hub drive.
